(19) United States
(12) Patent Application Publication
(10) Pub. No.: US 2014/0033102 A1
(43) Pub. Date: Jan. 30, 2014

(54) TASK-BASED USER WORKSPACE

(71) Applicant: Ethan A. Eismann, Oakland, CA (US)

(72) Inventor: Ethan A. Eismann, Oakland, CA (US)

(21) Appl. No.: 12/201,352

(22) Filed: Aug. 29, 2008

(51) Int. Cl. G06F 3/048

(52) U.S. Cl. 715/771

(57) ABSTRACT

A method includes receiving a task selection that identifies a task within a display area, the display area displaying content and an object. The content is translated, based upon the task, from a first format to a second format. The object is replaced with a further object, based upon the task, the replacing being displayed in the display area as a transition animation. The s content and the further object are displayed within the display area.

### COPYRIGHT

A portion of the disclosure of this document includes material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever. The following notice applies to the software, data, and/or screenshots that may be illustrated below and in the drawings that form a part of this document: Copyright © 2008, Adobe Systems Incorporated. All Rights Reserved.

### TECHNICAL FIELD

The present application relates generally to the technical field of algorithms and programming and, in one specific example, Graphical User Interfaces (GUIs).

### BACKGROUND

GUIs serve as the interface between a software application and a user. The ease of use of the interface typically dictates the ease of use of the software application. This ease of use may be defined by how the interface allows the user to perform a task using the software application. A task may be software application specific in that a particular software application may be used to perform a specific task.

### BRIEF DESCRIPTION OF THE DRAWINGS

Some embodiments are illustrated by way of example and not limitation in the figures of the accompanying drawings in which:

FIG. 1 is a diagram of a system, according to an example embodiment, used to select a task template.

FIG. 2 is a diagram of a system, according to an example embodiment, for generating a task template.

FIG. 3 is a diagram of the task GUI, according to an example embodiment, used to display a workspace and a task for the workspace.

FIG. 4 is a diagram of a task GUI, according to an example embodiment, illustrating the selection of a new task type.

FIG. 5 is a diagram of a task GUI, according to an example embodiment, illustrating changing of a task associated with the task GUI and a transition animation.

FIG. 6 is a diagram of a task GUI, according to an example embodiment, illustrating an export task type and associated panel, and objects.

FIG. 7 is a block diagram of a computer system, according to an example embodiment, that is used to retrieve a task template.

FIG. 8 is a flow chart illustrating a method, according to an example embodiment, used to display content and a panel based upon a task.

FIG. 9 is a flow chart illustrating the execution of a method, according to an example embodiment, used to implement the task template.

FIG. 10 is a flow chart illustrating execution of an operation, according to an example embodiment, that translates objects and layouts using a template for a selected task.

FIG. 11 is a flow chart illustrating execution of an operation, according to an example embodiment, to translate content to a new format.

FIG. 12 is a flow chart illustrating execution of an operation, according to an example embodiment, to generate a task template.

FIG. 13 is a flow chart illustrating an example method, according to an example embodiment, to render a new workspace.

FIG. 14 is a dual-stream flow chart illustrating an example method, according to an example embodiment, used to implement a task template in a networked environment.

FIG. 15 is an example Relational Data Schema (RDS), according to an example embodiment.

FIG. 16 shows a diagrammatic representation of a machine in the form of a computer system, according to an example embodiment, that executes a set of instructions to perform any one or more of the methodologies discussed herein.

### DETAILED DESCRIPTION

In the following description, for purposes of explanation, numerous specific details are set forth in order to provide a thorough understanding of an example embodiment of the present invention. It may be evident, however, to one skilled in the art that the present invention will be practiced without these specific details.

In some example embodiments, a system and method are provided that generate a task-based user workspace. A task is an operation that is performed by, for example, a software application, or a hardware module. A workspace is a display area of a GUI that is used to facilitate the completion of the task. A GUI is a type of user interface which allows users to interact with electronic devices such as cell phones, computer systems, Personal Digital Assistants (PDA), and/or smart phones. A GUI may provide access to a development environment, wherein development may be browser based, or part of a stand-alone software application. Example software applications may include Adobe CREATIVE SUITE®, PHOTOSHOP®, ACROBAT®, COLD FUSION®, DREAMWAVER®, IN-DESIGN®, FLASH®, ILLUSTRATOR®, FIREWORKS®, ENCORE®, FLEX®, or some other suitable software application.

In one example embodiment, a task-based user workspace is changed such that the task to be performed within the workspace changes, but the content (e.g., digital content) displayed therein does not change. In cases where the task changes, prior task panels (e.g., generically referenced herein as a panel), including objects that are used to perform the task, are replaced with new task panels (e.g., a panel used in a design process or a design panel) including objects for a different task. A task panel is a discrete area of a task GUI that is used to group software objects. Objects may include tools, commands, widgets, or some other suitable software object. A tool is a program or application used to create, debug, maintain, or otherwise support other software programs and applications. A tool may be represented graphically via an icon. A command is a directive to a computer program to perform a specific task. A command may be represented graphically via an icon. A widget is an element of a GUI that displays an information arrangement changeable by the user. Content includes graphically represented programming language objects, visual text, images, audio-video, or other suitable content. A programming language object is a data representation that has associated methods and attributes written in a programming language such as ActionScript, JavaScript, Java, C++, C#, or some other suitable programming language. Visual text includes text data and graphics formatted using a Portable Document Format (PDF), a Rich Text Format (RTF), an Open Document Format (ODF), an Office Open eXtensible Markup Language (XML) format, a Hyper Text Markup Language (HTML) format, or some other suitable format. An image includes data formatted using the Joint Photographic Experts Group (JPEG) format, Graphics Interchange Format (GIF), Tagged Image File Format (TIFF), Portable Network Graphics (PNG), or some other suitable file format. Audio-video content includes content formatted using the Moving Picture Experts Group (MPEG) format, the TrueMotion VP6 (VP6) format, the H.264 format, the H.265 format, or some other suitable file format.

In some example embodiments, where the task changes, the replacement of the prior task panels by the new task panel is represented via a transition animation. A transition animation is a graphical representation of a change in a workspace. For example, the replacement of the prior task panel by the new task panel is presented by the prior task panel visually moving out of view of the user in the workspace, while the new task panel simultaneously visually moves onto the workspace.

In some example embodiments, where the task changes the content displayed within the workspace transitions to a new format necessary to perform the new task. A transition is a conversion from one format to another format. A format is a method of organizing data. For example, if the prior task was to develop content in the form of an interface for a software application, this interface may be displayed as rendered HTML. If the new task is to print out this interface as a physical document, then the HTML may be converted into a new format, such as a PDF, so as to facilitate the task of printing out the interface.

In some example embodiments, the system and method shown herein use a task template to translate the content from one format to another format. A task template is a schema for an object and the layout of objects as displayed within content. In one example embodiment, the task template is written using XML, wherein the XML is used to wrap the content to give the content a new format that can be used to accomplish the newly selected task. The layout may be a Document Object Model (DOM), JAVA™-DOM (JDOM), or some other suitable model for organizing objects displayed in content. In some example embodiments, the template may be implemented via a scripting language where the scripting language may include ACTIONSCRIPT™, PERL™, PHYTHON™, JAVA™, JAVA SCRIPT™, VISUAL BASIC SCRIPT™, or some other suitable scripting language. In some example embodiments, the task template is stored as a Shockwave Flash File (SWF).

### Example System

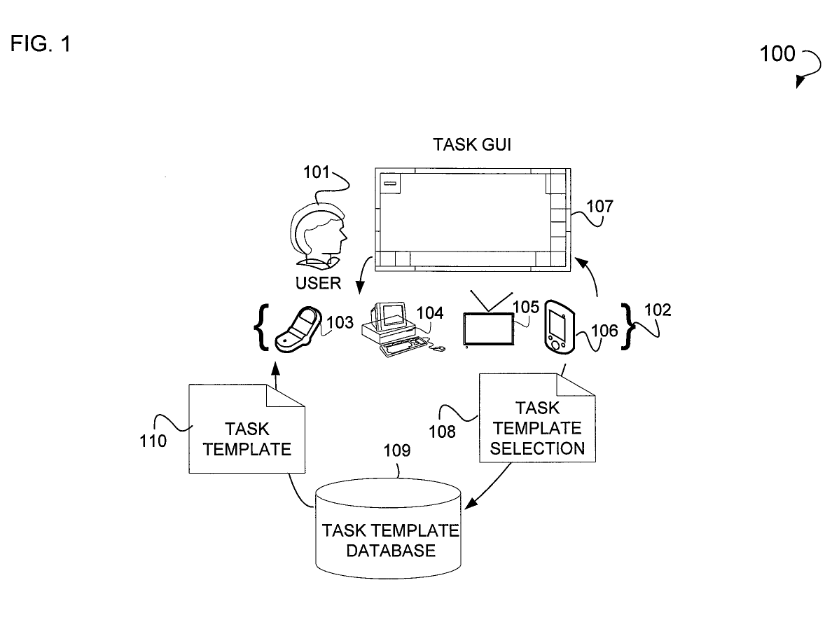

FIG. 1 is a diagram of an example system 100 used to select a task template. Shown is a user 101 who uses a task GUI 107. This task GUI 107 is generated by any one of a number of devices 102. These devices 102 include, for example, a cell phone 103, a computer system 104, a television or monitor 105, a Personal Digital Assistant (PDA) 106, or a smart phone (not shown). Using this task GUI 107, the user 101 generates a task template selection 108. The task template selection 108 includes instructions identifying a task template. These instructions may be written in XML. The task denoted by this task template is selected from a number of possible tasks presented to the user 101 via the task GUI 107. This task template selection 108 is stored into a task template database 109 that is operatively connected to the devices 102. This operative connection may include, for example, a logical or physical connection. The task template database 109 may be native or non-native to the devices 102. A task template 110 is retrieved from the task template database 109, and used to organize the task GUI 107 and the content displayed therein. Organizing includes dictating a layout, the format of the object included in this layout, and the scaling of content within the task GUI 107.

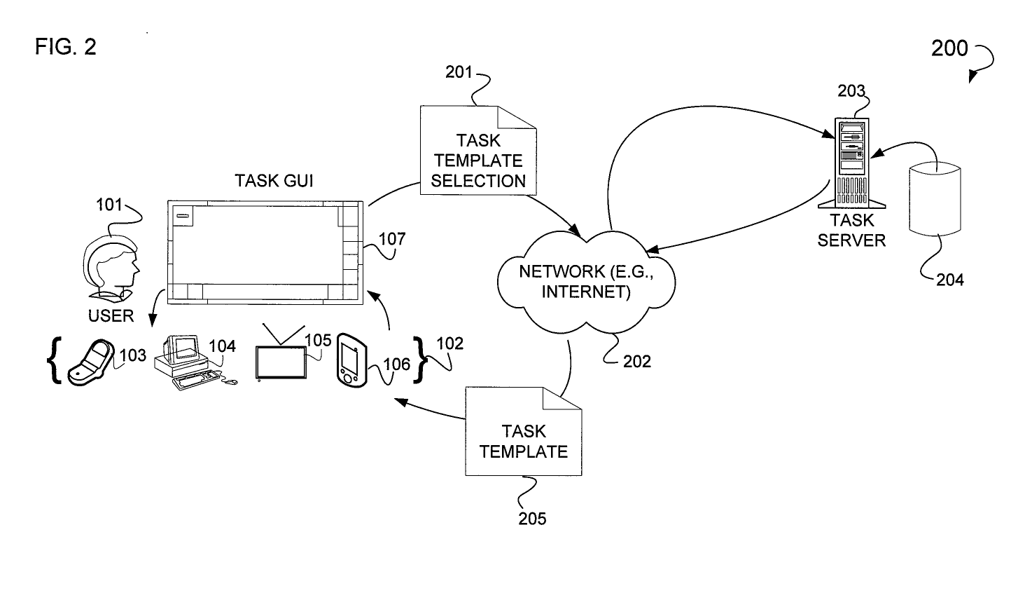

FIG. 2 is a diagram of an example system 200 for generating a task template. Shown is the user 101 using one of the devices 102 to generate a task template selection 201. This task template selection 201 includes instructions identifying a task. The task denoted by this task template is selected from a number of possible tasks presented to the user 101 via the task GUI 107. These instructions may be written in XML, a Session Description Protocol (SDP), or some other suitable language. The task template selection is transmitted over a network 202 and received by a task server 203. Operatively connected to the task server 203 is a task template database 204. In some example embodiments, a web server and/or database server is used in conjunction with the task server 203. The task template database 204 may be native or non-native to the task server 203. The task server 203 retrieves the task template 205 and transmits it across the network 202. The task template 205 is received by the devices 102, processed and used to organize the task GUI 107, and contents displayed therein.

### Example Interfaces

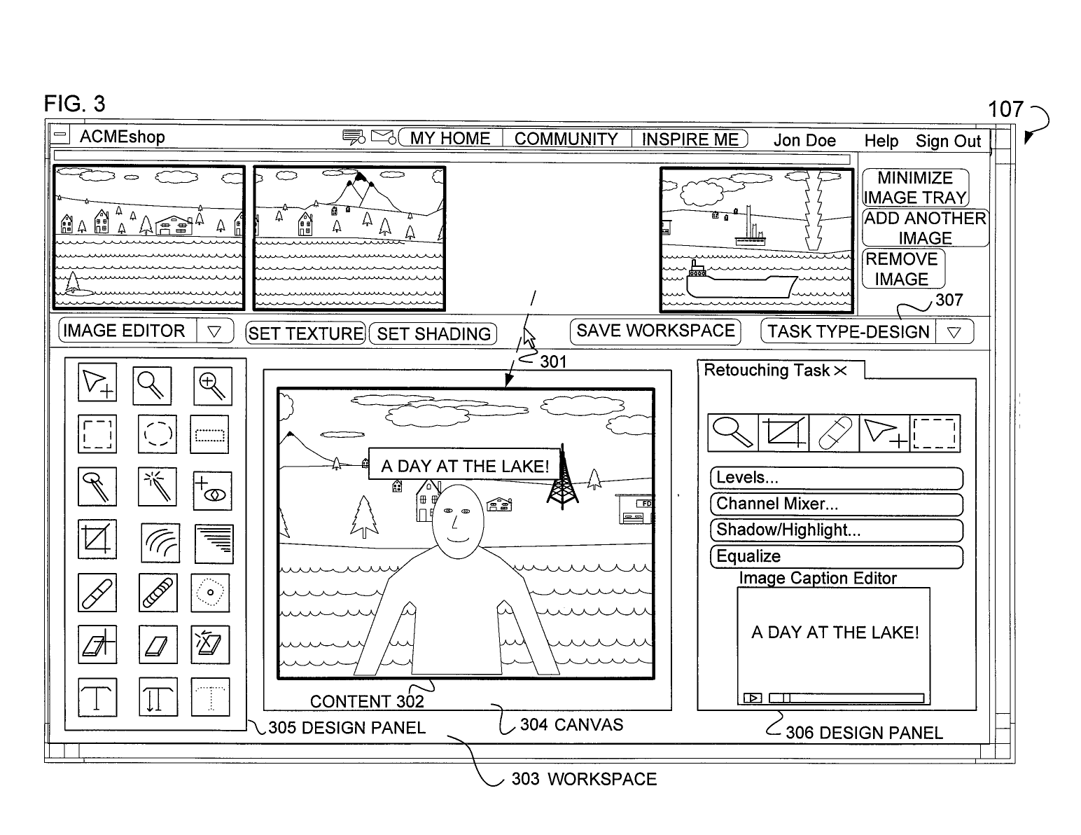

FIG. 3 is a diagram of an example task GUI 107. Shown is a graphical pointer 301 that is used to move content 302 onto a canvas 304. In some example embodiments, a graphical pointer 301, controlled by an input device, is used to select certain functionality (e.g., to select a task) that is displayed as part of the task GUI 107. The graphical pointer is a cursor and the input device may be a mouse, keyboard, light pen, touch screen, or other suitable input device. Selection of the functionality may be by way of the execution of a right-click function, a mouse-over function, or a left-click function, through the use of the input device. Further, the input device is used to select (e.g., focus upon) the functionality that is displayed as part of the task GUI 107. Focus indicates the object of the task GUI 107 which is currently selected to receive input. The functionality may be embodied in a GUI object or widget. A widget is an element of a GUI that displays an information arrangement changeable by the user 101, such as a drop-down menu, a check box, a window or a text box. Content 302 is modified using, for example, one or more tools that are displayed as a part of a design panel 305. Further, additional tools are displayed as part of the design panel 306. The content 302, canvas 304 and design panels 305 and 306 reside as a part of workspace 303. The canvas 304 is a display area that allows for a user to interact with the content displayed in the display area. The user 101, using the graphical pointer 301, selects a task from the drop-down menu 307. This task may be a design task or, as will be discussed below, an export task. Export includes the conversion of a file into another format (e.g., an exported format). Once exported, the file can be used by an application that recognizes the exported format. A file that is exported can also be transmitted across the network 202 for processing by the additional application. Other possible tasks include the edit task, the formatting task, or some other suitable task.

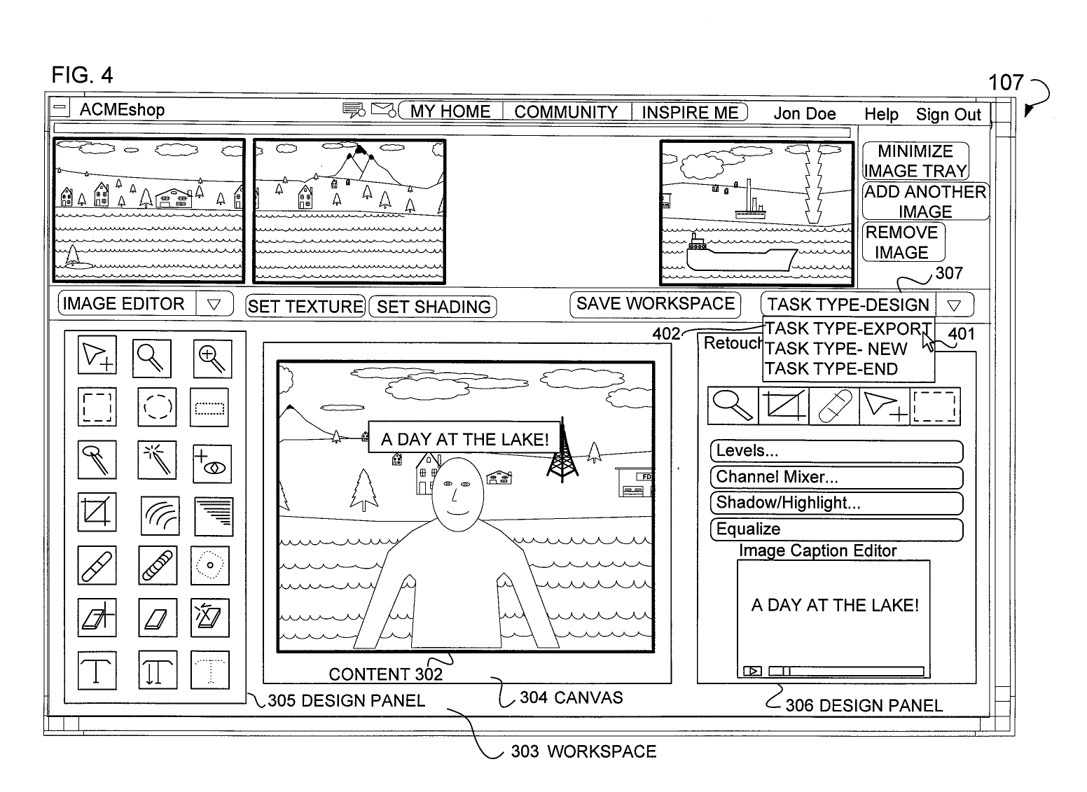

FIG. 4 is a diagram of an example task GUI 107 illustrating the selection of a new task type. A graphical pointer 401 is used, for example, by the user 101 to select a task type (e.g., receiving a task selection) from the task drop-down menu 307. Here a task type of export is selected from the drop-down menu 307, as denoted at 402. In some example embodiments, some other suitable task type is selected. Through the selection of a new task type, the workspace 303 is more fully illustrated below will be modified to reflect the new task.

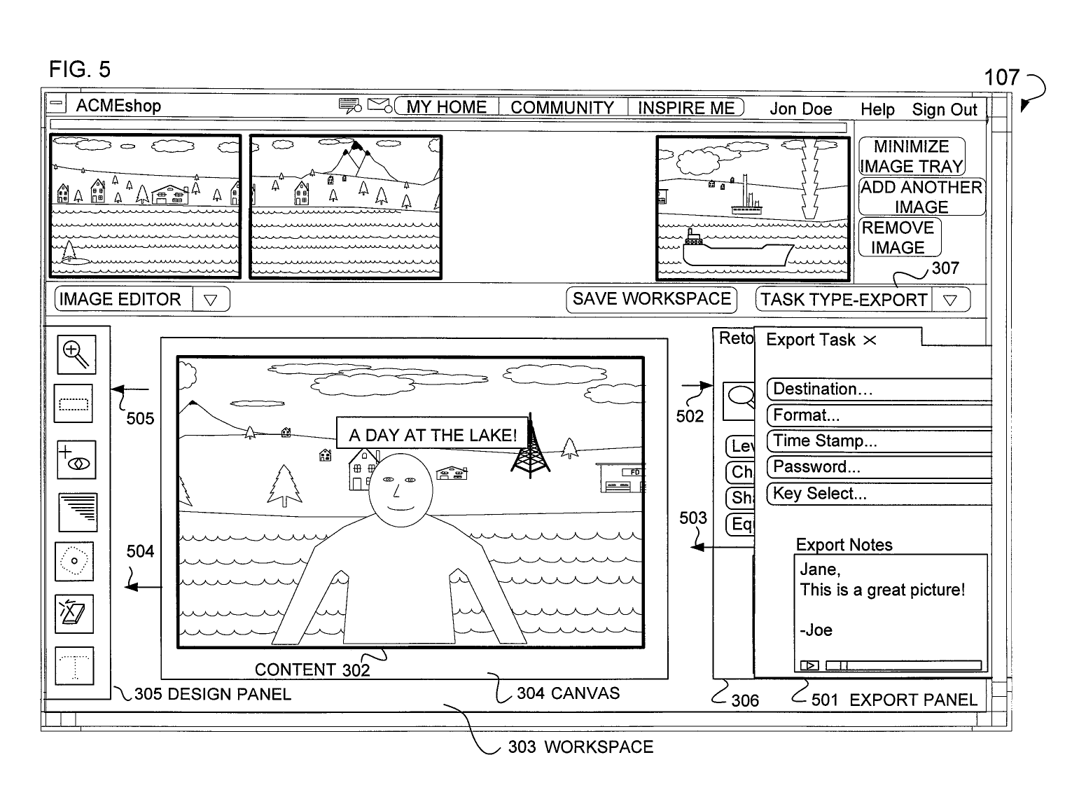

FIG. 5 is a diagram of an example task GUI 107 illustrating the changing of a task associated with the task GUI 107 and a corresponding transition animation used to change the panels associated with this task and to rescale the content displayed within this task GUI 107. Shown is an export panel 501 that is moved into a position into the workspace 303. In some example embodiments, simultaneous with the positioning of the export panel 501, the previously shown design panel 306 is removed. The transition animation for the export panel 501 and design panel 306 is shown at 502 and 503. At 502, the design panel 306 exits from the workspace 303, and at 503, the export panel 501 enters into the workspace. Further, at 504 and 505, transition animation illustrates the resealing or scaling of the content 302 within the canvas 304 and more generally the workspace 303. At 504, the content 302 is rescaled to occupy a larger area within the canvas 504 and more generally within the workspace 303. An area is defined in terms of pixel values. Simultaneously, the design panel 305 exits from the workspace 303. Larger area includes occupying a larger area of the workspace 303, than was previously occupied.

In some example embodiments, transition animation is a graphical representation of a change in the workspace 303. This change may include a task panel moving off of the workspace in a visually detectable or discernible manner (e.g., the user 101 can view the task panel moving off or onto the workspace 303). This change may include objects moving off of the workspace in a visually detectable or discernible manner. Moving off (e.g., moving out of view of the user 101 in the task GUI 107) includes departing the workspace 303 with a diagonal movement, an orthogonal movement to other object or panels on the workspace 303, a perpendicular movement to other objects and panels in the workspace 303, or some other suitable movement off the workspace 303. Additionally, the movement also includes a fade-out, where the task panel and/or objects fade from view of the workspace 303. A fade-out is the process of causing the task panel and/or object to gradually darken and disappear. A transition animation also includes a movement onto (e.g., a movement into view of the user 101 in the task GUI 107) the workspace 303 by a task panel and/or object. This movement onto the workspace 303 includes the previously mentioned types of movement. A fade-in may be used whereby the task panel and/or object gradually lightens and appears within the workspace 303 for viewing by the user 101. The movement onto or off the workspace 303 by the task panels and/or objects may by simultaneous, piecemeal, or distinct in nature. In some example embodiments, the transition animation includes additional movements such as a flicker, pulse, wipe, or dissolve into or out of view. A combination of the above outlined movements may also be used as a movement.

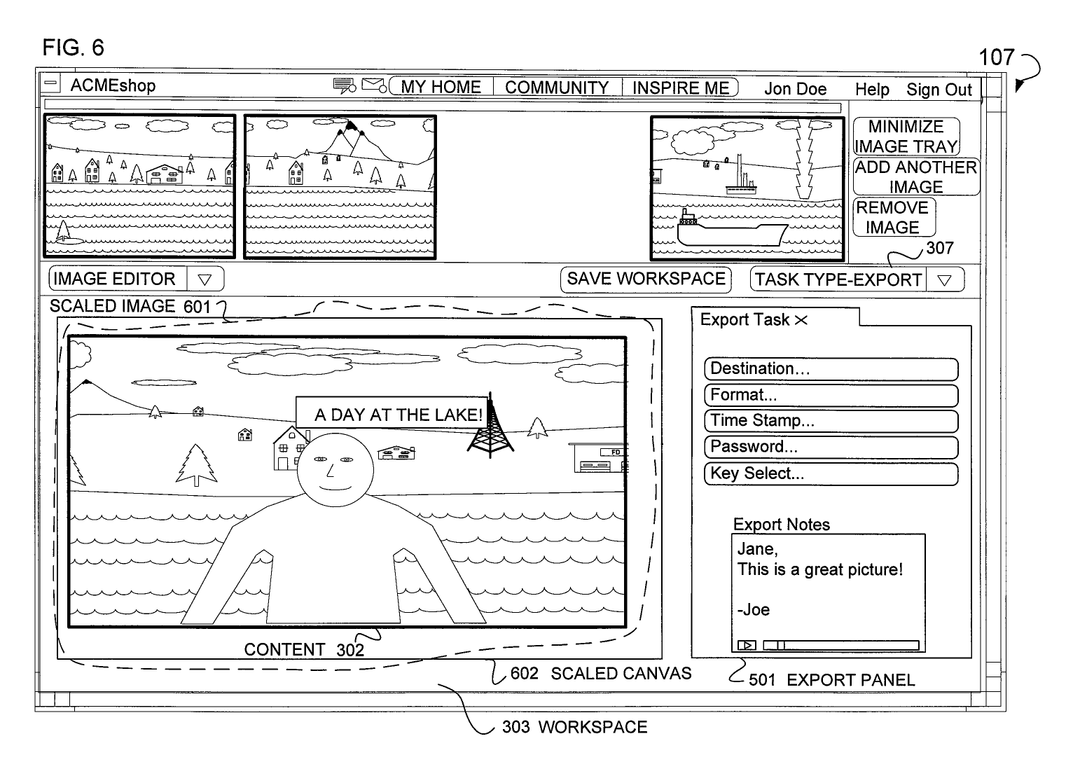

FIG. 6 is a diagram of an example task GUI 107 illustrating an export task type. A scaled image 601 includes the content 302 that has been rescaled within the scaled canvas 602. The scaled image 601 and scaled canvas 602 reside within the workspace 303. In some example embodiments, the content 302 has been reformatted using a format that can be more readily used for by the application or device to which the content 302 is being exported. This resealing occurs with little or distortion to the image as initially displayed or rendered (see e.g., FIG. 3.). For example, in FIG. 3 a design task was taking place such that the content 302 is a JPEG formatted image. By contrast, in FIG. 6 where an export is taking place, the content 302 is formatted using, for example, a PDF formatting type.

### Example Logic

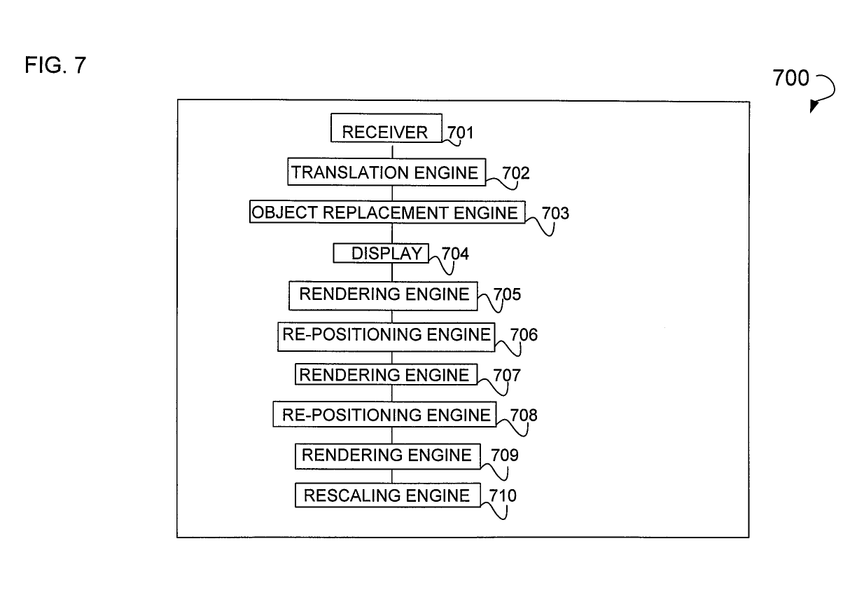

FIG. 7 is a block diagram of an example computer system 700 that is used to display content and a panel based upon a task. The blocks shown herein may be implemented in software, firmware, or hardware. These blocks may be directly or indirectly communicatively coupled via a physical or logical connection. The computer system 700 may be the one or more devices 102. Shown are blocks 701 through 710. Illustrated is a receiver 701 a receiver to receive a task selection that identifies a task within a display area, the display area displaying content and an object. Communicatively coupled to the receiver 701 is a translation engine 702 to translate the content, based upon the task, from a first format to a second format. Communicatively coupled to the translation engine 702 is an object replacement engine 703 to replace the object with a further object, based upon the task, the replacing being displayed in the display area as a transition animation. Communicatively coupled to the object replacement engine 703 is a display 704 to display the translated content and the further object within the display area. In some example embodiments, the transition animation includes a movement from view of the object in the display area, the movement of the object relative to the further object and including at least one of an orthogonal movement, a diagonal movement, a horizontal movement, a vertical movement, a perpendicular movement, or a fade-out movement. In some example embodiments, the transition animation includes a movement into view of the further object in the display area, the movement of the further object being relative to the object and including at least one of an orthogonal movement, a diagonal movement, a horizontal movement, a vertical movement, a perpendicular movement, or a fade-in movement.

In some example embodiments, the transition animation generated by the computer system 700 is facilitated through the use of a rendering engine 705 to render the object and the further object in the display area for viewing. This rendering engine 705 is communicatively coupled to the display 704. Communicatively coupled to the rendering engine 705 is a re-positioning engine 706 to change the position of the object from a first position to a second position in the display area such that the object is removed from view in the display area. Communicatively coupled to the re-positioning engine 706 is an additional rendering engine 706 to render the further object in the display area. In some example embodiments, the transition animation is facilitated through the use of a rendering engine 707 to render the object and the further object in the display area for viewing. Communicatively coupled to the rendering engine 707 is a re-positioning engine 708 to change the position of the further object from a first position to a second position in the display area such that the further object is moved into view in the display area. Communicatively coupled to the re-positioning engine 708 is an additional rendering engine 709 to render the further object in the display area. In some example embodiments, transition animation includes a display of a simultaneous removal of the object from the display area, and an addition of the further object to the display area. In some example embodiments, the display area is included in a GUI. In some example embodiments, the format is a file format. Further, the replacing the object with a further object, based upon the task, includes using a template to wrap the object in an XML tag. Wrapping includes encapsulating the code representing the object in an XML tag. Additionally, the object includes at least one of a panel, a tool, a command, or a widget. Moreover, the content is displayed as part of the display area that includes a canvas. Communicatively coupled to the rendering engine 709 is a rescaling engine 710 to rescale the content, the resealing including a change in area occupied by the content within the display area. In some example embodiments, the resealing is based upon the task selection.

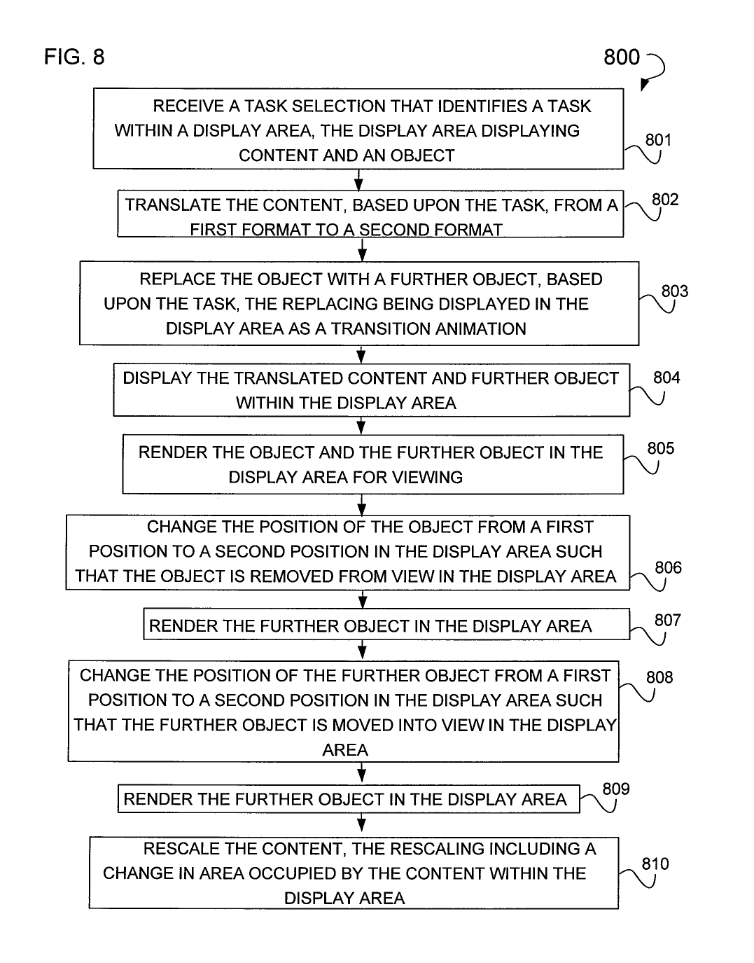

FIG. 8 is a flow chart illustrating an example method 800 used to display content and a panel based upon a task. The various operations 801 through 808 may be executed by the one or more devices 102. Illustrated is an operation 801 that is executed by the receiver 701 to receive a task selection that identifies a task within a display area, the display area displaying content and an object. This receiver 701 may be an input device. Operation 802 is executed by the translation engine 702 to translate the content, based upon the task, from a first format to a second format. This translation engine may be an interpreter, or compiler. Operation 803 is executed by the object replacement engine 703 to replace the object with a further object, based upon the task, the replacing being displayed in the display area as a transition animation. Operation 804 is executed by the display 704 to display the translated content and the further objects within the display area. In some example embodiments, the transition animation includes a movement from view of the object in the display area, the movement of the object relative to the further object and including at least one of an orthogonal movement, a diagonal movement, a horizontal movement, a vertical movement, a perpendicular movement, or a fade-out movement. In some example embodiments, the transition animation includes a movement into view of the further object in the display area, the movement of the further object being relative to the object and including at least one of an orthogonal movement, a diagonal movement, a horizontal movement, a vertical movement, a perpendicular movement, or a fade-in movement.

In some example embodiments, the method 800 includes the execution of an operation 805 by the rendering engine 705 to render the object and the further object in the display area for viewing. Operation 806 is executed by the re-positioning engine 706 to change the position of the object from a first position to a second position in the display area such that the object is removed from view in the display area. Operation 807 is executed by the rendering engine 707 to render the further object in the display area. The transition animation may include executing the operation 805 to render the object and the further object in the display area for viewing. Operation 808 is executed by the re-positioning engine 708 to change the position of the further object from a first position to a second position in the display area such that the further object is moved into view in the display area. Operation 809 is executed by the rendering engine 709 to render the further object in the display area. Some example embodiments may include, transition animation that includes a display of a simultaneous removal of the object from the display area, and an addition of the further object to the display area. In some example embodiments, the display area is included in a GUI (e.g., task GUI 107). In some example embodiments, the format is a file format. The replacing the object with a further object, based upon the task, includes using a template to wrap the object in an XML tag. The object includes at least one of a panel, a tool, a command, or a widget. The content is displayed as part of a display area that includes a canvas (e.g., canvas 304). Operation 810 is executed by the rescaling engine 710 to rescale the content, the rescaling including a change in area occupied by the content within the display area. The rescaling is based upon the task selection.

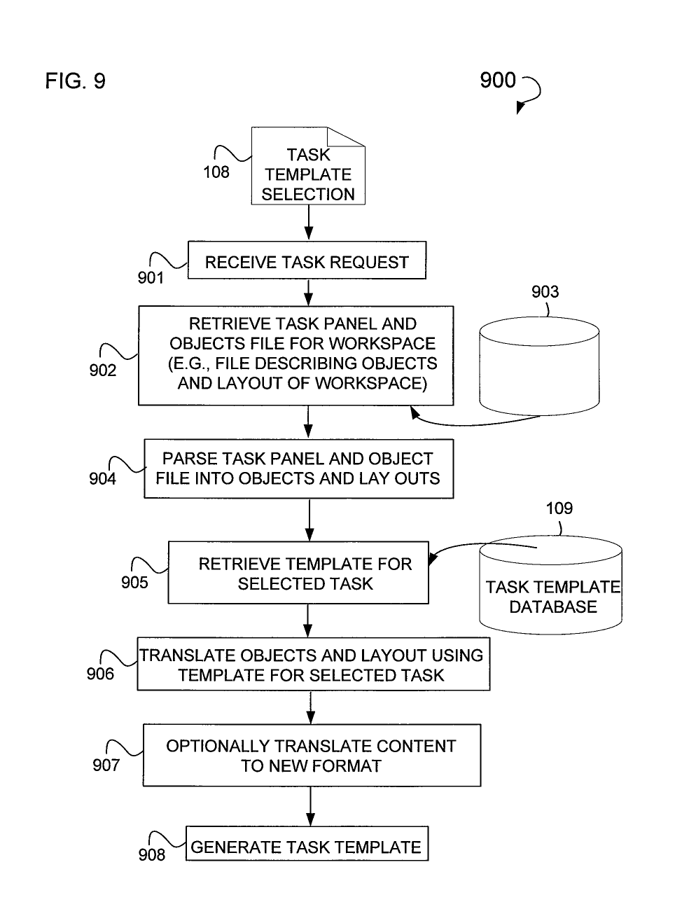

FIG. 9 is a flow chart illustrating the execution of an example method 900 used to implement the task template 110. Illustrated are various operations 901 through 908 that are executed by one of the devices 102. Shown is the task template selection 108 that is received through the execution of operation 901. Operation 902 is executed that retrieves an task panel and object file for the workspace 303. This task panel and object is retrieved based upon the task to be performed. This task panel and object file is retrieved from the task panel and object file data store 903. This data store may be a persistent or non-persistent data store. This may be located natively or non-natively on the one or more of the devices 102. An operation 904 is executed that parses the task panel and object file into objects and layouts. Objects include the panel and the previously referenced tools, commands, widgets, or some other suitable software object. Layouts include DOMs and JDOMs. Operation 905 is executed that retrieves a template for a selected task. This template may be retrieved from the task template database 109. Operation 906 is executed that translates the objects and layouts using a template for the selected task. Operation 907 is executed to optionally translate content to a new format. Translation includes converting from one file format to another file format (e.g., HTML to PDF). In some example embodiments, operation 907 is not optional. Operation 908 is executed to generate the task template 110.

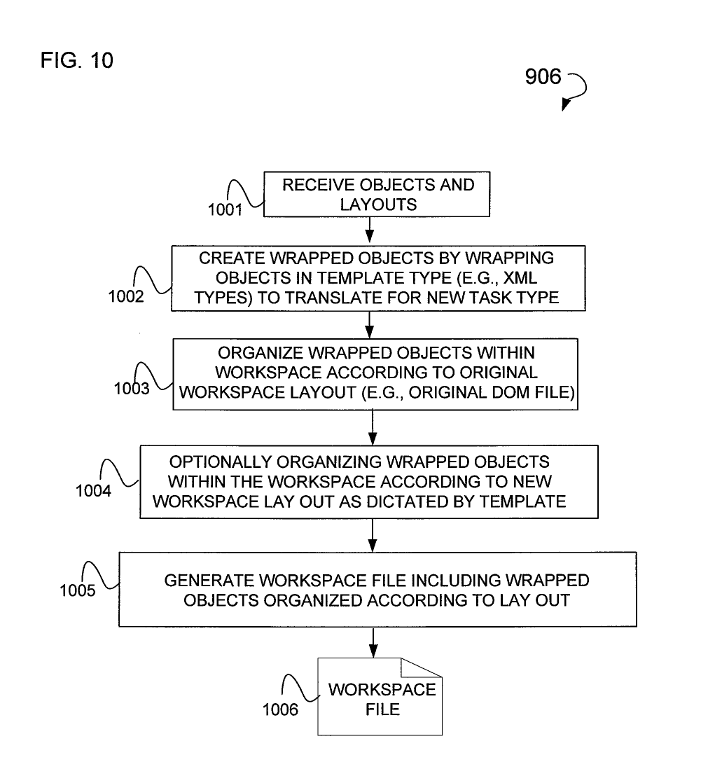

FIG. 10 is a flow chart illustrating the execution of an example operation 906. Shown is an operation 1001 that, when executed, receives objects and layouts. Operation 1002 is executed that creates wrap objects by wrapping the objects in a template type to translate for a new task type. This template type may be an XML defined type. Through wrapping these objects in a template type, these objects are translated for a particular task type (e.g., a new task type). For example, through using the XML types, objects are translated from objects used for design purposes to objects used for export purposes. Operation 1003 is executed that organizes the wrap objects within a workspace according to an original workspace layout. Operation 1004 is executed that optionally organizes wrapped objects within the workspace according to a new workspace layout as dictated by a template. Operation 1005 is executed to generate a workspace file that includes wrapped objects organized according to a layout. This canvas file is reflected as workspace file 1006.

In some example embodiments, the tasks, based upon which an object is translated, are multifarious. For example, a design task may be implemented, wherein content in the form of a web page is written in HTML. This web page may need to be re-designed using XML. In this case, the task may still be design, but the content and design panels may change to address the new design task. Design panels specific to XML design may replace the previous panels specific to the task of HTML design. This content may be reformatted from HTML to XML. In another example embodiment, the task may change from a print task to an edit task. For example, a content formatted in PDF and associated print panels used in printing a document, may be replaced with content formatted as a Microsoft WORD™ document, an OPEN OFFICE™ document, or WORDPERFECT™ document and associated editing panels common to word processing.

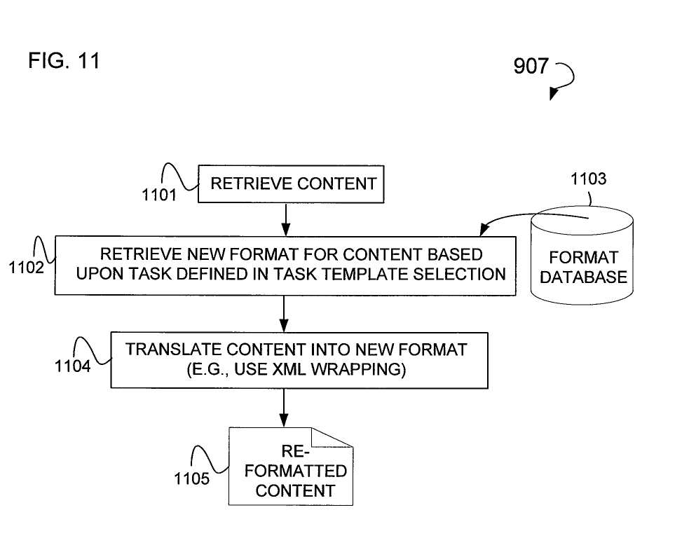

FIG. 11 is a flow chart illustrating the execution of an example operation 907. Shown is an operation 1101 that retrieves content such as content 302. Operation 1102 is executed that retrieves a new format for content based upon tasks defined in the task template selection. The format is retrieved from a format database 1103. This format database 1103 may be a persistent or non-persistent data store. This format database 1103 may be a native or non-native database that is operatively connected to one of the devices 102. Operation 1104 is executed to translate the content 302 into a new format using, for example, XML wrapping. Re-formatted content is generated through the execution of operation 1105.

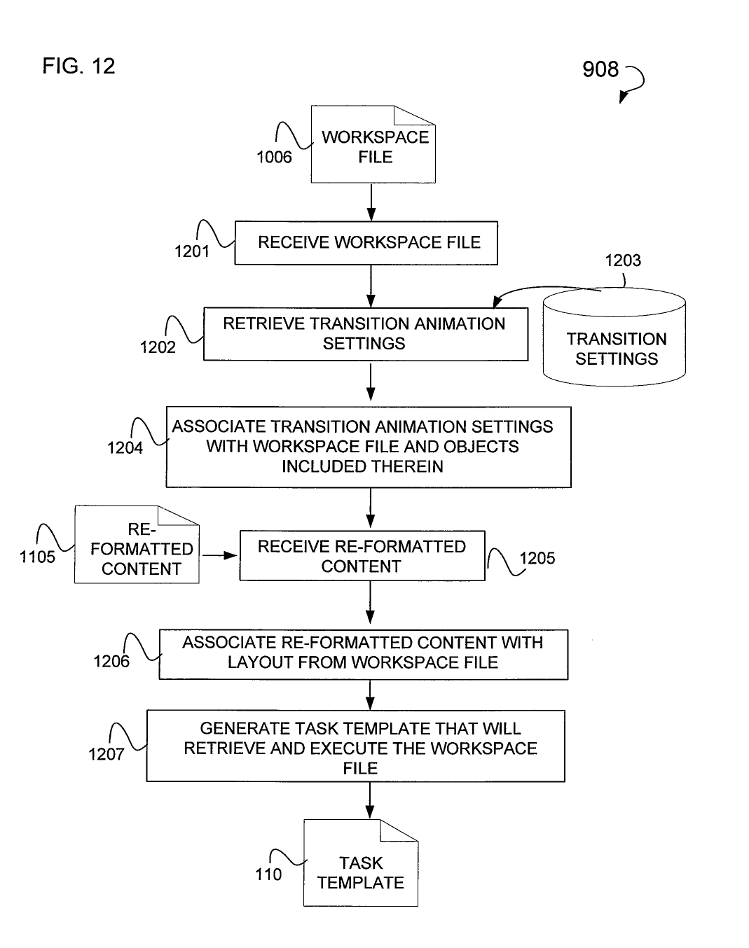

FIG. 12 is a flow chart illustrating the execution of an example operation 908. Shown is the workspace file 1006 that has received the execution of operation 1201. Operation 1202 is executed to retrieve transition animation settings. These settings may be set by the user 101, or may be preset based upon the task being performed. The transition animation settings are retrieved from a transition settings database 1203. This transition settings database 1203 may be a persistent or non-persistent data store. This transition settings database 1203 may be a native or non-native database that is operatively connected to one of the devices 102. Operation 1204 is executed to associate transition animation settings with the workspace file and objects included therein. Association may include making the transition animation a software object that has a workspace file as part of an inheritance relationship. Operation 1205 is executed to receive the re-formatted content 1105. Operation 1206 is executed to associate the re-formatted content with the layout from the workspace file. Association includes the layout having reformatted content as part of an inheritance relationship. Operation 1207 is executed to generate the task template 110 that retrieves and executes the workspace file.

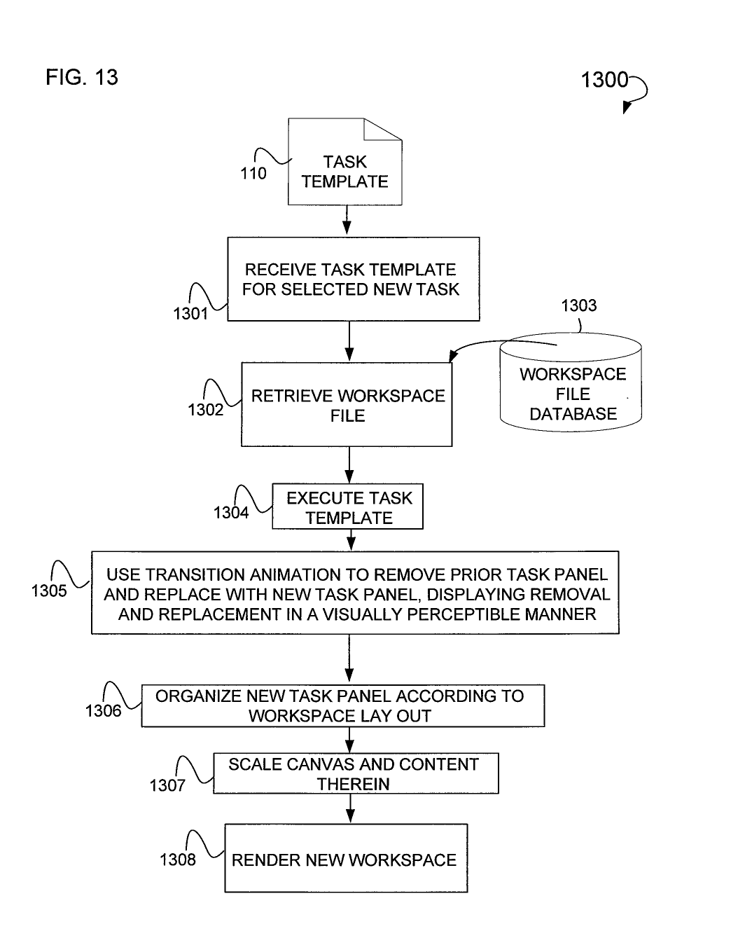

FIG. 13 is a flow chart illustrating an example method 1300 to render a new workspace. This method 1300 may be executed by one of the devices 102. Shown is an operation 1301 that is executed to receive a task template for selected new tasks. Operation 1302 is executed to retrieve a workspace file from the workspace file database 1303. Operation 1304 is executed to execute the template. This operation 1304 may include the execution of operation 1305 that, when executed, uses transition animation to remove prior task panels and to replace them with new task panels based upon a new task. Objects may also be removed and replaced. Operation 1306 is executed to organize the new task panel according to a workspace lay out. Operation 1307 is executed to scale the canvas 304 and content 302. This scale includes increasing or decreasing the area occupied by the content and canvas within the workspace 303. Operation 1308 is executed to render the workspace using the task template 110.

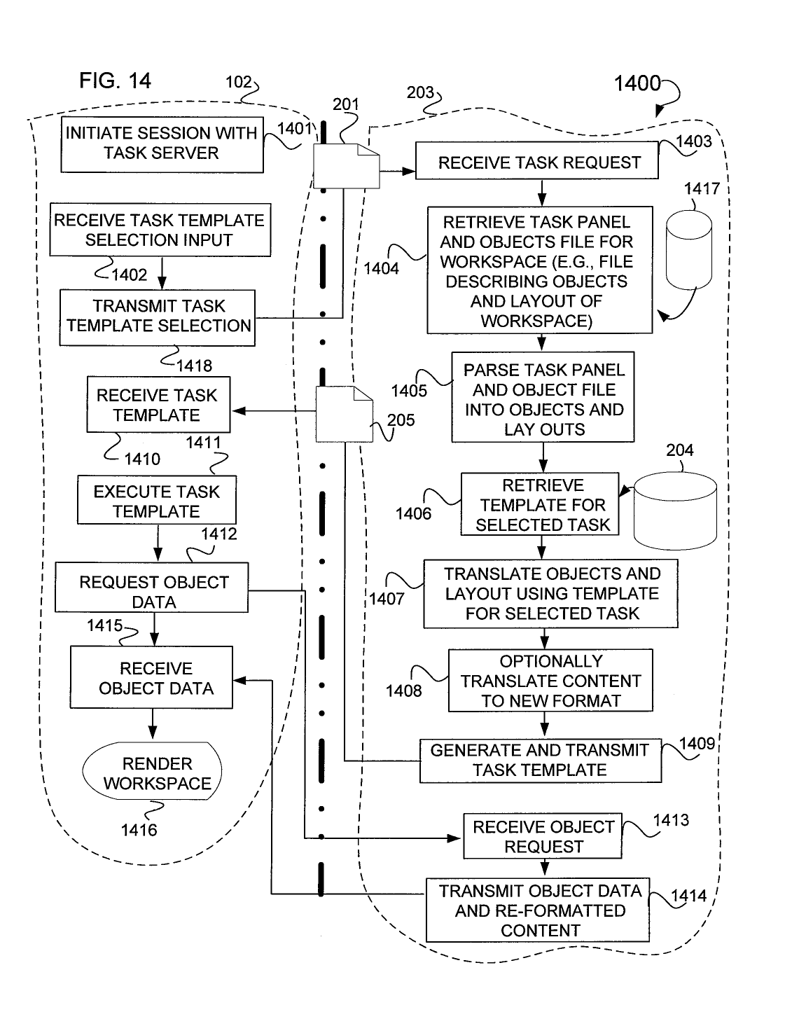

FIG. 14 is a dual-stream flow chart illustrating an example method used to implement a task template 205 in a networked environment. Shown are operations 1401 1402, 1418, and 1410 through 1412, and 1415 through 1416 that are executed by the devices 102. Also shown are operations 1403 through 1409, database 1417, and operations 1413 through 1414 that are executed by the task server 203. Operation 1401 is executed to set a session between the devices 102 and the task server 203. This session may be a Transmission Control Protocol/Internet Protocol (TCP/IP), a login or some other suitable type of session. An operation 1402 is executed to receive task template selection input (e.g., to select a task). Operation 1418 is executed to transmit a task template selection 201. Operation 1403 is executed to receive a task request. Operation 1404 is executed to retrieve a task panel and object file for a workspace from the database 1417. Database 1417 may be a persistent or non-persistent data store. Database 1417 may be native or non-native to the task server 203. Operation 1405 is executed to parse the task panel and object file into objects and layouts. Operation 1406 is executed to retrieve the template for a selected task as outlined in the task template selection 201. The template is retrieved from the task template database 204. Operation 1407 is executed to translate objects and layout using the template for selected tasks. Operation 1408 is executed to optionally translate content to a new format. Operation 1409 is executed to generate and transmit a task template 205. Operation 1410 is executed to receive the task template 205. Operation 1411 is executed to execute the task template through compiling or interpreting the task template 205. Operation 1412 is executed to request object data from the task server 203. Object data includes data relating to an object to be displayed in the task GUI 107. Objects include tools, commands, widgets, or some other suitable software object. Operation 1413 receives the object data request, while operation 1414 retrieves and transmits the object data and, in some example embodiments, the re-formatted content. Operation 1415 is executed to receive object data. A workspace is rendered in display 1416.

### Example Database

Some embodiments may include the various databases (e.g., 109, 803, and 1003) being relational databases, or, in some cases, Online Analytic Processing (OLAP)-based databases. In the case of relational databases, various tables of data are created and data is inserted into and/or selected from these tables using a Structured Query Language (SQL) or some other database-query language known in the art. In the case of OLAP databases, one or more multi-dimensional cubes or hyper cubes, including multidimensional data from which data is selected from or inserted into using a Multidimensional Expression (MDX) language, may be implemented. In the case of a database using tables and SQL, a database application such as, for example, MYSQL™, MICROSOFT SQL SERVER™, ORACLE 8I™, 10G™, or some other suitable database application may be used to manage the data. In this, the case of a database using cubes and MDX, a database using Multidimensional On Line Analytic Processing (MOLAP), Relational On Line Analytic Processing (ROLAP), Hybrid Online Analytic Processing (HOLAP), or some other suitable database application may be used to manage the data. The tables or cubes made up of tables, in the case of, for example, ROLAP, are organized into an RDS or Object Relational Data Schema (ORDS), as is known in the art. These schemas may be normalized using certain normalization algorithms so as to avoid abnormalities such as non-additive joins and other problems. Additionally, these normalization algorithms may include Boyce-Codd Normal Form or some other normalization or optimization algorithm known in the art.

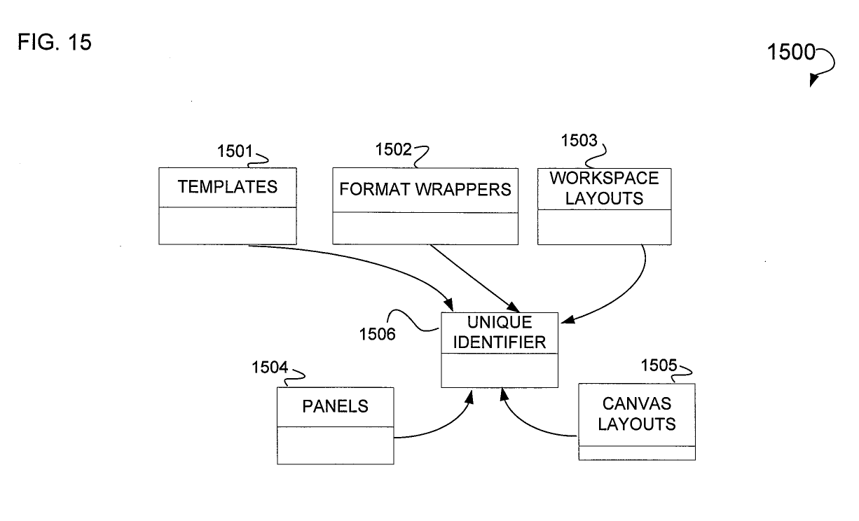

FIG. 15 is an example Relational Data Schema (RDS) 1500. Shown is a table 1501 that contain templates. These templates may include layouts and objects relating to a particular workspace. Further, the transition animation information to add or remove objects from this workspace 303 may also be included. An XML data type may be used as a data type to save the templates contained within the table 1501. The table 1502 is shown that contains format wrappers. These format wrappers may be XML-based tagging information that is used to wrap components or layouts for the purposes of transitioning these components or layouts from one format to another format. For example, through using a format wrapper, transitioning may take place to allow digital content to be formatted. For example, the format digital content is changed from a JPEG format to a PDF format. An XML data type may be used to store the date within the table 1502. Table 1503 includes workspace layouts. These workspace layouts may be, for example, a DOM that is used to dictate the structure of the particular workspace. This DOM may be stored as, for example, an XML data type or some other suitable data type. Table 1504 includes panels. These panels include, for example, objects or widgets associated with a particular frame or area (e.g., a panel). These panels may be stored as, for example, an XML data type, a Binary Large Object (BLOB) or some other suitable data type. Table 1505 is shown that includes canvas layouts. These canvas layouts may be, for example, a DOM and may be stored as, for example, an XML data type. Table 1506 contains unique identifier information for each of the entries in the tables 1501 through 1505. This unique identifier information may be, for example, a key that is saved as, for example, an integer data type.

### Distributed Computing Components and Protocols

Some example embodiments may include remote procedure calls being used to implement one or more of the above-illustrated components across a distributed programming environment. For example, a logic level may reside on a first computer system that is located remotely from a second computer system including an interface level (e.g., a GUI). These first and second computer systems can be configured in a server-client, peer-to-peer, or some other configuration. The various levels can be written using the above-illustrated component design principles and can be written in the same programming language or in different programming languages. Various protocols may be implemented to enable these various levels and the components included therein to communicate regardless of the programming language used to write these components. For example, an operation written in C++ using Common Object Request Broker Architecture (CORBA) or Simple Object Access Protocol (SOAP) can communicate with another remote module written in Java. Suitable protocols include SOAP, CORBA, and other protocols well-known in the art.

### A Computer System

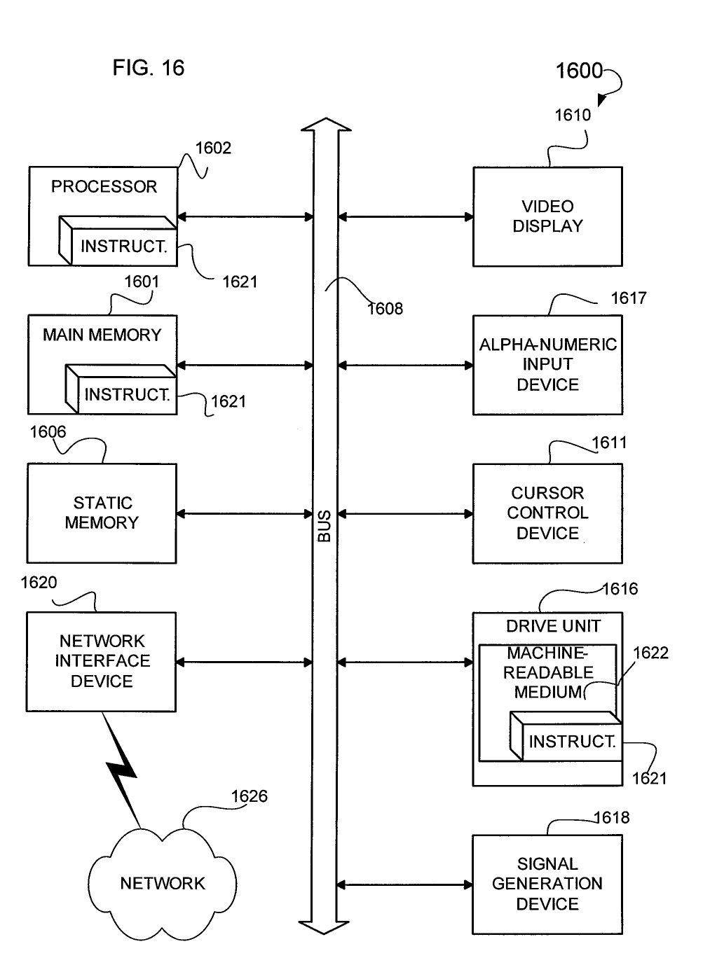

FIG. 16 shows a diagrammatic representation of a machine in the example form of a computer system 1600 that executes a set of instructions to perform any one or more of the methodologies discussed herein. In alternative embodiments, the machine operates as a standalone device or may be connected (e.g., networked) to other machines. In a networked deployment, the machine may operate in the capacity of a server or a client machine in server-client network environment or as a peer machine in a peer-to-peer (or distributed) network environment. The machine may be a Personal Computer (PC), a tablet PC, a Set-Top Box (STB), a PDA, a cellular telephone, a Web appliance, a network router, a switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein. Example embodiments can also be practiced in distributed system environments where local and remote computer systems, which are linked (e.g., either by hardwired, wireless, or a combination of hardwired and wireless connections) through a network, both perform tasks such as those illustrated in the above description.

The example computer system 1600 includes a processor 1602 (e.g., a CPU, a Graphics Processing Unit (GPU) or both), a main memory 1601, and a static memory 1606, which communicate with each other via a bus 1608. The computer system 1600 may further include a video display unit 1610 (e.g., a Liquid Crystal Display (LCD) or a Cathode Ray Tube (CRT)). The computer system 1600 also includes an alphanumeric input device 1617 (e.g., a keyboard), a User Interface (UI) (e.g., GUI) cursor controller 1611 (e.g., a mouse), a drive unit 1616, a signal generation device 1618 (e.g., a speaker) and a network interface device (e.g., a transmitter) 1620.

The disk drive unit 1616 includes a machine-readable medium 1622 on which is stored one or more sets of instructions and data structures (e.g., software) 1621 embodying or used by any one or more of the methodologies or functions illustrated herein. The software instructions 1621 may also reside, completely or at least partially, within the main memory 1601 and/or within the processor 1602 during execution thereof by the computer system 1600, the main memory 1601 and the processor 1602 also constituting machine-readable media.

The instructions 1621 may further be transmitted or received over a network 1626 via the network interface device 1620 using any one of a number of well-known transfer protocols (e.g., Hyper Text Transfer Protocol (HTTP), Secure Hyper Text Transfer Protocol (HTTPS)).

The term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding, or carrying a set of instructions for execution by the machine and that cause the machine to perform any one or more of the methodologies illustrated herein. The term “machine-readable medium” shall accordingly be taken to include, but not be limited to, solid-state memories, optical and magnetic media, and carrier wave signals.

### Marketplace Applications

In some example embodiments, a system and method is shown for displaying transition animations for objects within a GUI based upon tasks to be performed within the GUI. These transition animations occur while the format of the content within the GUI changes and the content is rescaled to occupy additional space within the GUI. In some example embodiments, an object associated with a first task moves from view within the GUI and another object moves into view in the GUI. These respective movements may occur simultaneously. In some example embodiments, the system and method illustrated herein may be useful to address issues related to effective transitions between various GUI functionality. For example, rather than a user experiencing a discrete transition between GUIs for a particular software application, where GUI appear and disappear, a transition animation is provided that allows the transition to be contiguous. That is, for example, the transition of panels is contiguous, rather than discrete. This transition animation allows the user to maintain focus on one GUI that changes to reflect the current task.

The Abstract of the Disclosure is provided to comply with 37 C.F.R. §1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment.

1. A method comprising:
receiving a task selection of a task icon displayed within a display area of a task-based work space, the display area displaying content and an object, the content being modifiable using the object;
translating, using one or more processors, the content from a first file format to a second file format based on the task selection, the first file format and the second file format being file formats compatible with the task-based work space;
replacing the object with a further object based on the task selection, the replacing being displayed in the display area as a transition animation wherein the transition animation comprises a graphical representation of the object visually moving out of view of a user of the display area, while the further object simultaneously visually moves onto the display area; and
displaying the translated content and the further object within the display area.

2. The method of claim 1, wherein the transition animation includes a movement from view of the object in the display area, the movement of the object being relative to the further object and including at least one of an orthogonal movement, a diagonal movement, a horizontal movement, a vertical movement, a perpendicular movement, or a fade-out movement.

3. The method of claim 1, wherein the transition animation includes a movement into view of the further object in the display area, the movement of the further object being relative to the object and including at least one of an orthogonal movement, a diagonal movement, a horizontal movement, a vertical movement, a perpendicular movement, or a fade-in movement.

4. The method of claim 1, wherein the transition animation includes:
rendering the object and the further object in the display area for viewing;
changing the position of the object from a first position to a second position in the display area such that the object is removed from view in the display area; and
rendering the further object in the display area.

5. The method of claim 1, wherein the transition animation includes:
rendering the object and the further object in the display area for viewing;
changing the position of the further object from a first position to a second position in the display area such that the further object is moved into view in the display area; and
rendering the further object in the display area,

6. The method of claim 1, wherein the transition animation includes a display of a simultaneous removal of the object from the display area, and an addition of the further object to the display area.

7. The method of claim 1, wherein the display area is included in a Graphical User Interface (GUI).

8. (canceled)

9. The method of claim 1, wherein the replacing of the object with a further object based on the task selection includes using a template to wrap the object in an eXtensible Markup Language (XML) tag.

10. The method of claim 1, wherein the object includes at least one of a panel, a tool, a command, or a widget.

11. The method of claim 1, wherein the content is displayed as part of the display area that includes a canvas.

12. The computer implemented method of claim 1, further comprising resealing the content, the resealing including a change in area occupied by the content within the display area.

13. The computer implemented method of claim 12, wherein the resealing is based on the task selection.

14. A computer system comprising:
a receiver to receive a task selection of a task icon displayed within a display area of a task-based work space, the display area displaying content and an object, the content being modifiable using the object;
a translation engine, having one or more processors, to translate the content from a first file format to a second file format based on the task selection, the first file format and the second file format being file formats compatible with the task-based work space;
an object replacement engine to replace the object with a further object based on the task selection, the replacing being displayed in the display area as a transition animation wherein the transition animation comprises a graphical representation of the object visually moving out of view of a user of the display area, while the further object simultaneously visually moves onto the display area; and
a display to display the translated content and the further object within the display area.

15. The computer system of claim 14, wherein the transition animation includes a movement from view of the object in the display area, the movement of the object being relative to the further object and including at least one of an orthogonal movement, a diagonal movement, a horizontal movement, a vertical movement, a perpendicular movement, or a fade-out movement.

16. The computer system of claim 14, wherein the transition animation includes a movement into view of the further object in the display area, the movement of the further object being relative to the object and including at least one of an orthogonal movement, a diagonal movement, a horizontal movement, a vertical movement, a perpendicular movement, or a fade-in movement.

17. The computer system of claim 14, wherein transition animation includes:
a rendering engine to render the object and the further object in the display area for viewing;
a re-positioning engine to change the position of the object from a first position to a second position in the display area such that the object is removed from view in the display area; and
a further rendering engine to render the further object in the display area.

18. The computer system of claim 14, wherein transition animation includes:
a rendering engine to render the object and the further object in the display area for viewing;
a re-positioning engine to change the position of the further object from a first position to a second position in the display area such that the further object is moved into view in the display area; and
a further rendering engine to render the further object in the display area,

19. The computer system of claim 14, wherein transition animation includes a display of a simultaneous removal of the object from the display area, and an addition of the further object to the display area.

20. The computer system of claim. 14, wherein the display area is included in a Graphical User Interface (GUI).

21. (canceled)

22. The computer system of claim 14, wherein the replacing of the object with a further object based on the task selection includes using a template to wrap the object in an eXtensible Markup Language (XML) tag.

23. The computer system of claim 14, wherein the object includes at least one of a panel, a tool, a command, or a widget.

24. The computer system of claim 14, wherein the content is displayed as part of the display area that includes a canvas.

25. The computer system of claim 14, further comprising a resealing engine to rescale the content, the resealing including a change in area occupied by the content within the display area.

26. The computer system of claim 25, wherein the resealing is based on the task selection.

27. An apparatus comprising:
means for receiving a task selection of a task icon within a display area of a task-based. work space, the display area displaying content and an object, the content being modifiable using the object;
means for translating the content from a first file format to a second file format based on the task selection, the first file format and the second file format being file formats compatible with the task-based work space;
means for replacing the object with a further object based on the task selection, the replacing being displayed in the display area as a transition animation wherein the transition animation comprises a graphical representation of the object visually moving out of view of a user of the display area, while the further object simultaneously visually moves onto the display area; and
means for displaying the translated content and the further object within the display area.

28. A non-transitory machine-readable medium comprising instructions, which when implemented by one or more machines, cause the one or more machines to perform. the hollowing operations comprising:
receiving a task selection of a task icon displayed within a display area of a task-based workspace, the display area displaying content and an object, the content being modifiable using the object;
translating the content from a first file format to a second file format based on the task selection, the first file format and the second file format being file formats compatible with the task-based work space;
replacing the object with a further object based on the task selection, the replacing being displayed in the display area as a transition animation wherein the transition animation comprises a graphical representation of the object visually moving out of view of a user of the display area, while the further object simultaneously visually moves onto the display area; and
displaying the translated content and the further object within the display area.

29. The method of claim 1, wherein the content is selected from the group consisting of graphically represented programming language objects, visual text, images, and audio-video content.

30. The system of claim 14, wherein the content is selected from the group consisting of graphically represented programming language objects, visual text, images, and audio-video content.
